(19) United States
(12) Patent Application Publication
(10) Pub. No.: US 2012/0010899 A1
(43) Pub. Date: Jan. 12, 2012

(54) CLINICAL TEST INFORMATION SYSTEM AND NON-TRANSITORY STORAGE MEDIUM

(76) Inventors: Yukio Minato, Kobe-shi (JP); Syuichi Soyama, Fukuoka-shi (JP)

(21) Appl. No.: 13/179,023

(22) Filed: Jul. 8, 2011

(30) Foreign Application Priority Data
Jul. 12, 2010 (JP) 2010-158183

(51) Int. Cl. G06Q 50/00

(52) U.S. Cl. 705/2

(57) ABSTRACT

A clinical test information system configured to: receive, through an operation of the input unit, a selection of one of a first display form and a second display form for displaying a plurality of test items in a classified state; and cause, if receiving the selection of the first display form, a display unit to display a screen showing the plurality of test items in a state classified according to a first category, and cause, if receiving the selection of the second display form, the display unit to display a screen showing the plurality of test items in a state classified according to a second category. Also, a non-transitory storage medium which can be used in the test information system.

### RELATED APPLICATIONS

This application claims priority under 35 U.S.C. §119 to Japanese Patent Application No. 2010-158183 filed on Jul. 12, 2010, the entire content of which is hereby incorporated by reference.

### BACKGROUND OF THE INVENTION

1. Field of the Invention

The present invention relates to a clinical test information system for managing information of tests performed by a testing apparatus, and to a non-transitory storage medium which can be used in the test information system.

2. Description of the Related Art

In medical institutions such as hospitals and testing institutions, a testing system has been introduced that manages, by using computers, information of operations from requests for performing tests on samples issued by a medical doctor to reporting of results of the tests performed by analyzers. In such a testing system, when a request for performing tests on samples of a patient is issued by a medical doctor, order information including sample testing items is inputted to a data management apparatus. A laboratory technician sends sample containers in accordance with the sample testing items to corresponding testing departments. Analyzers perform tests on the samples based on the order information inputted to the data management apparatus. Then the test results are stored in the data management apparatus to be reported to the medical doctor.

Japanese Laid-open Patent Publication No. 11-142411 discloses a testing system which allows unified management of data by connecting a plurality of analyzers and a plurality of data management apparatuses arranged in laboratories. In this testing system, various types of information such as order information and sample information, are displayed on the screens of the data management apparatuses in each laboratory.

When the above-described testing system is used, a user such as a laboratory technician or the like performs, by referring to order information displayed on the screen, a variety of testing operations such as checking inputs of test items, adding/correcting test items, checking the number of sample containers to be tested, and checking the types of analyzers which will use sample containers.

However, there may be a case where the user is required to have a certain level of experiences or skills for obtaining information desired by the user from the order information displayed on the screen. Therefore, it is desired that any user can smoothly perform testing operations while looking at the display screen, irrespective of his or her level of skills in the testing operations.

In the testing system disclosed in Japanese Laid-open Patent Publication No. 11-142411, how the sample order information is displayed on the screen is not taken into consideration at all.

The present invention has been made in view of the above situations, and provides a test information system which allows a user to smoothly perform testing operations by using information regarding test items displayed on a display unit, and a non-transitory storage medium used in the system.

### SUMMARY OF THE INVENTION

The scope of the present invention is defined solely by the appended claims, and is not affected to any degree by the statements within this summary.

According to a first aspect of the present invention, a clinical test information system comprising:
a memory configured to store test orders of patients;
a display unit configured to display a screen showing a plurality of test items included in a test order of a specific patient, the test order being stored in the memory;
an input unit; and
a controller configured to:
   receive, through an operation of the input unit, a selection of one of a first display form and a second display form for displaying the plurality of test items in a classified state; and
   cause, if receiving the selection of the first display form, the display unit to display a screen showing the plurality of test items in a state classified according to a first category, and cause, if receiving the selection of the second display form, the display unit to display a screen showing the plurality of test items in a state classified according to a second category.

According to a second aspect of the present invention, a clinical test information system comprising:
an order receiving section configured to receive test orders of patients;
a display unit configured to display a screen showing a plurality of test items included in a test order of a specific patient,
a selection receiving section configured to receive a selection of one of a first display form and a second display form for displaying the plurality of test items in a classified state; and
a display controller configured to:
   cause, if the selection receiving section has received the selection of the first display form, the display unit to display a screen showing the plurality of test item in a state classified according to a first category, and cause, if the selection receiving section has received the selection of the second display form, the display unit to display a screen showing the plurality of test items in a state classified according to a second category.

According to a third aspect of the present invention, a non-transitory storage medium which stores programs executable comprehensively by at least one processor, the programs causing the at least one processor to:
obtain test orders of patients;
receive a selection of one of a first display form and a second display form for displaying a plurality of test items included in a test order of a specific patient in a classified state; and
cause, if receiving the selection of the first display form, a display unit to display a screen showing the plurality of test items in a state classified according to a first category, and cause, if receiving the selection of the second display form, the display unit to display a screen showing the plurality of test items in a state classified according to a second category.

### BRIEF DESCRIPTION OF THE DRAWINGS

FIG. 1 is a schematic diagram showing an overall structure of a test information system according to an embodiment of the present invention.

FIG. 2 shows a hardware configuration of a server management apparatus.

FIG. 3 shows a functional configuration of the server management apparatus.

FIG. 4 shows an order registration screen including a test item display region.

FIG. 5 shows another display form of the test item display region.

FIG. 6 shows still another display form of the test item display region.

FIG. 7 shows a correcting operation screen for correcting a test item.

FIG. 8 is a table showing a data structure of test item setting information.

FIG. 9 is a perspective view showing an example of a sample container.

FIG. 10 is a flow chart showing a sequence of processes performed by the server management apparatus.

FIG. 11 is a flow chart showing a sequence of a screen operation process performed by the server management apparatus.

### DETAILED DESCRIPTION OF THE PREFERRED EMBODIMENTS

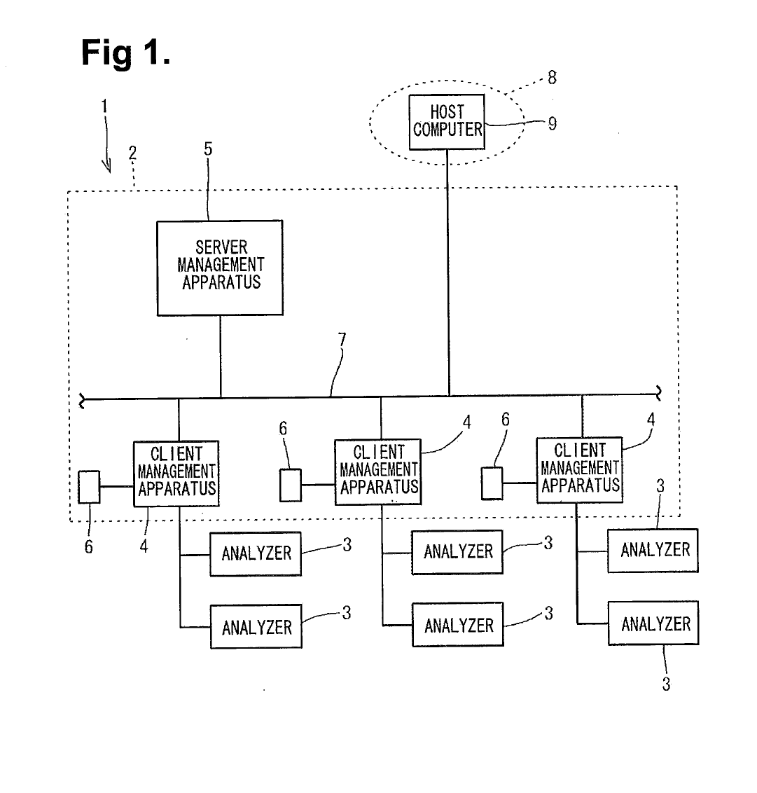

FIG. 1 is a schematic diagram showing an overall structure of a test information system according to an embodiment of the present invention.

A test information system (analyzing system) 1 in the present embodiment includes an analyzer (testing apparatus) 3 placed in a laboratory in a hospital or the like and configured to perform sample analysis, a management system 2 configured to manage test information and the analyzer 3, an ordering system 8 configured to receive registrations of test orders. The management system 2 is a client/server-type system including a server management apparatus 5 and a client management apparatus 4. In the example shown in FIG. 1, one server management apparatus 5 and a plurality of (three) client management apparatuses 4 are connected to each other via a communication line 7 in such a manner as to allow data communication.

A plurality of analyzers 3 are connected to each client management apparatus 4. For example, a variety of types of analyzers 3, such as blood cell analyzer, blood coagulation measuring apparatus, biochemical analyzer, immune analyzer, urine component analyzer (urine analyzer), and the like, are connected to a client management apparatus 4. A plurality of analyzers 3 configured to test blood samples are connected to a client management apparatus 4, and a plurality of analyzers 3 configured to test urine samples are connected to another client management apparatus 4. In this manner, a plurality of analyzers 3 using the same type of sample can be connected to one client management apparatus 4.

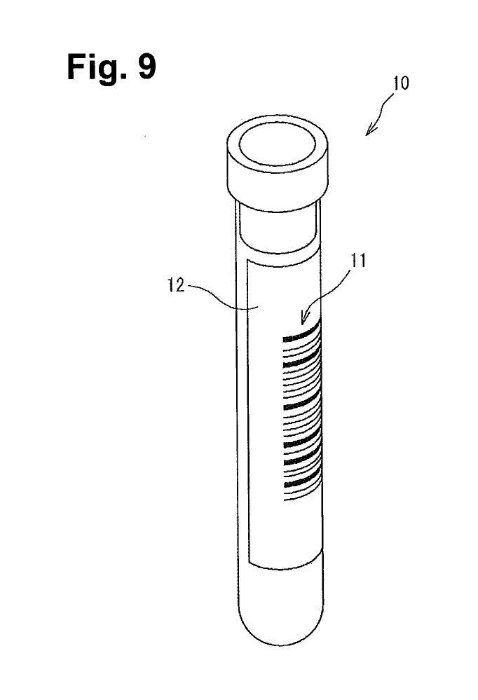

A label printer (printer) 6 configured to print a collection label 12 to be attached to a sample container 10 (see FIG. 9) for containing a sample is connected to each client management apparatus 4. The label printer 6 may be connected to the client management apparatus 4 but is not limited to being so, and may be connected to a network in a test information system 1.

The management system 2 is connected to the ordering system 8 in a hospital via the communication line 7. When a medical doctor determines that it is necessary to perform a test for a patient, the medical doctor inputs a test request (test order) to a terminal of the ordering system 8. The inputted test order is registered in a host computer 9 in the ordering system 8. The host computer 9 transmits the registered test order to the management system 2, and the server management apparatus 5 receives the test order. Each client management apparatus 4 inquires of the server management apparatus 5 about the test order, and causes analyzers 3 to perform tests based on the test order received from the server management apparatus 5. The server management apparatus 5 receives, from each client management apparatus 4, analysis results obtained from the analyzers 3, and registers the analysis results in a predetermined form into the host computer 9 in the ordering system 8, thereby reporting the results to the medical doctor or the like.

### [Hardware Configuration of Server Management Apparatus]

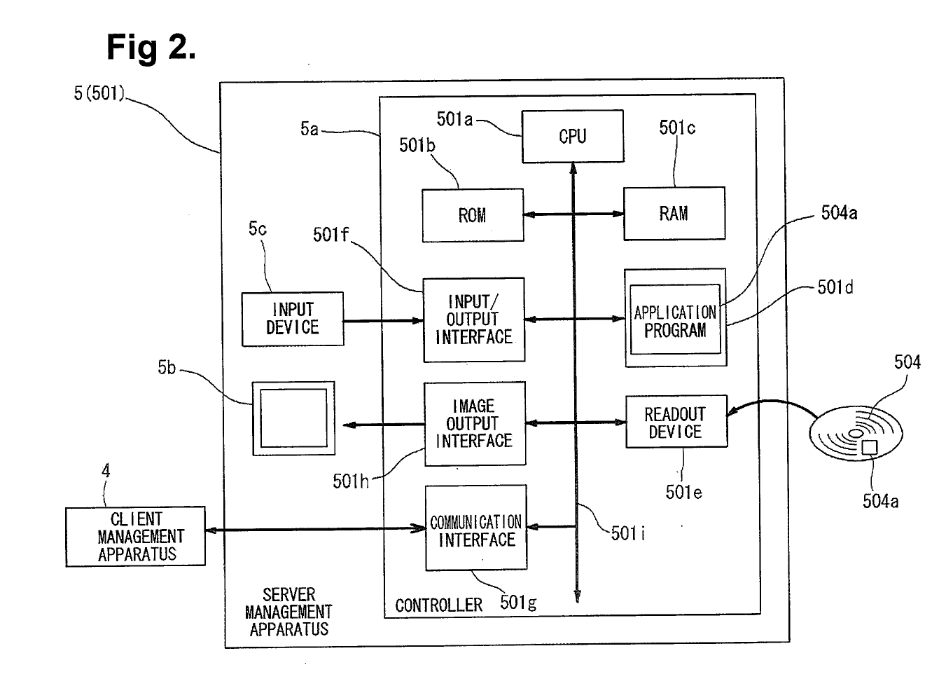

FIG. 2 shows a hardware configuration of the server management apparatus. The server management apparatus 5 is composed of a computer 501 which includes a controller 5a, a display unit 5b of a touch panel type, and an input device 5c. The controller 5a is mainly composed of a CPU 501a; a storage device which includes a ROM 501b, a RAM 501c, a hard disk 501d, and the like; a readout device 501e; an input/output interface 501f; a communication interface 501g; and an image output interface 501h, and these are connected to each other via a bus 501i.

A variety of computer programs, such as an operating system and application programs, to be executed by the CPU 501a, and data to be used for the execution of the computer programs are installed in the hard disk 501d. In the present embodiment, an application program 504a used for managing the test information and for managing the analyzers 3 is installed in the hard disk 501d. Moreover, various types of data such as test item setting information and the like are stored in the hard disk 501d.

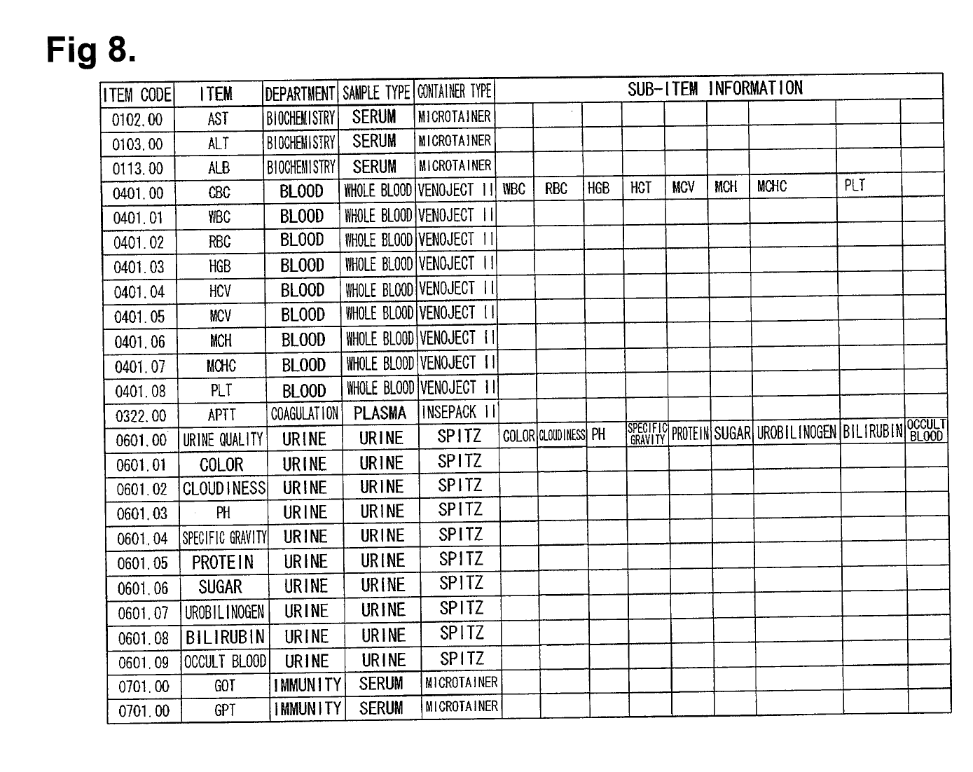

Information as test item setting information as shown in FIG. 8 is stored in the hard disk 501d. Specifically, with respect to all test items for which tests can be performed at a medical institution and the like where the test information system 1 has been introduced, “item code”, “item name”, “department”, “sample type”, “container type”, and “sub-item information” are stored, associated with each other. “Sub-item information” is set in a case where a test item has an item that is subordinate in a main-sub relationship. For example, “CBC” (Complete Blood Count) as a main-item has “WBC”, “RBC”, “HGB”, and the like as sub-items, and “urine quality” as a main-item has “color”, “cloudiness”, “PH”, and the like as sub-items.

As shown in FIG. 2, the display unit 5b, such as an LCD, a CRT, or the like, is connected to the image output interface 501h, and the input device 5c, such as a keyboard, a mouse, a touch panel, or the like, is connected to the input/output interface 501f.

The communication interface 501g is, for example, Ethernet (registered-trademark) interface. The computer 501 can transmit/receive data to/from other computers (client management apparatuses 4 and host computer 9) by using a predetermined communication protocol such as TCP/IP protocol or the like, by means of the communication interface 501g.

Each client management apparatus 4 is composed of a similar computer to the server management apparatus 5, and therefore, detailed description thereof will be omitted. The label printer 6 and a plurality of analyzers 3 are connected to the input/output interface of the client management apparatus 4. Moreover, application programs for realizing below-described functional configuration of the server management apparatus are installed in the hard disk of each client management apparatus 4. Accordingly, the client management apparatus 4 can exhibit functions substantially similar to those of the server management apparatus.

### [Functional Configuration of Server Management Apparatus]

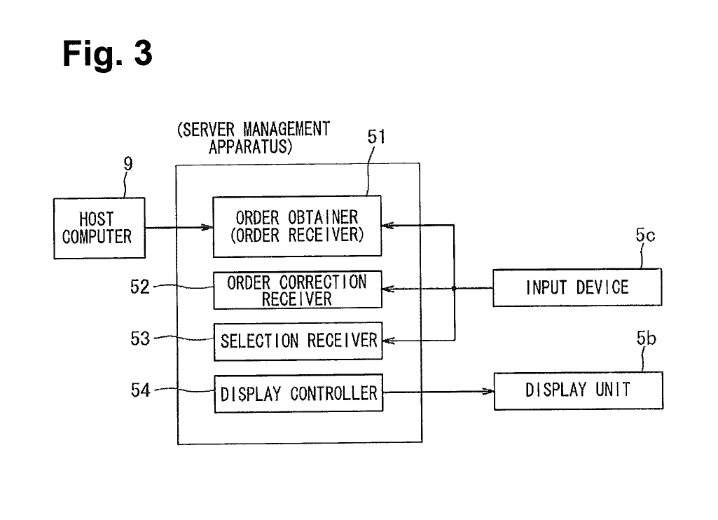

FIG. 3 shows a functional configuration of the server management apparatus. The server management apparatus 5 exhibits functions as shown in FIG. 3, by the CPU 501a of the controller 5a executing the application program 504a installed in the hard disk 501d.

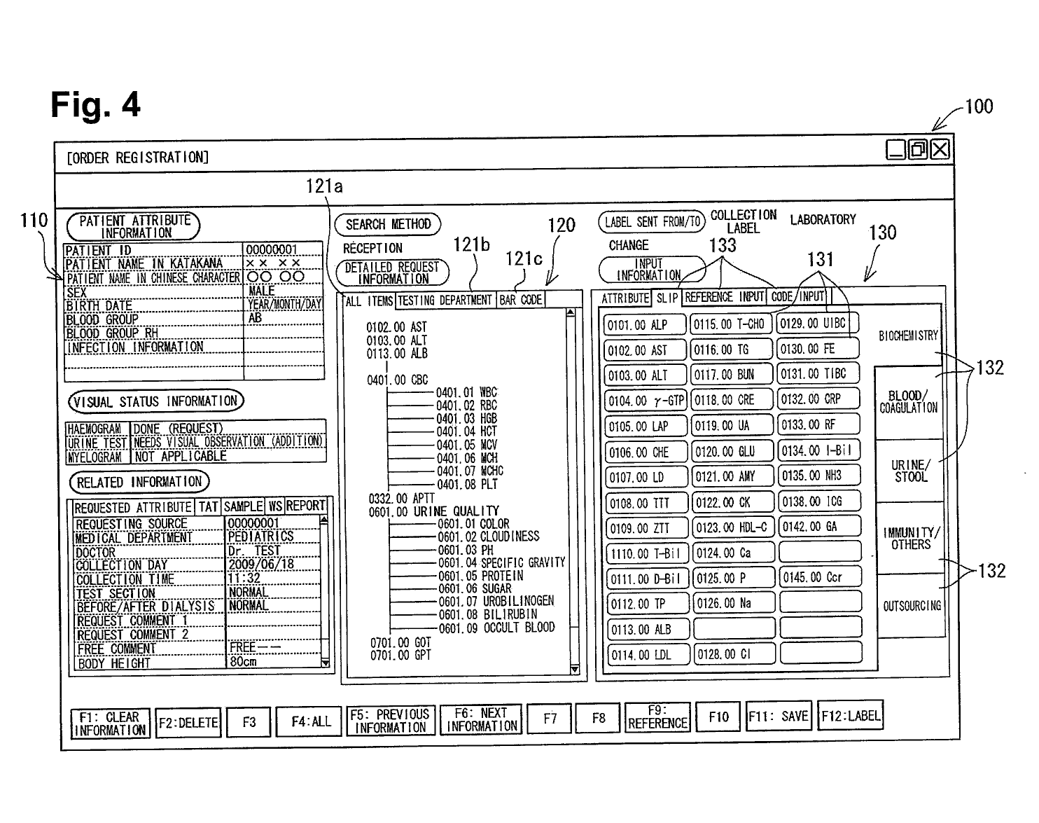

Specifically, the server management apparatus 5 includes an order obtainer (order receiver) 51 configured to obtain a test order from the ordering system 8 (see FIG. 1) or to directly receive a registration of a test order; and an order correction receiver 52 configured to receive a correction such as an addition or the like of a test item made onto the obtained test order. Moreover, the server management apparatus 5 includes a selection receiver 53 configured to receive a selection of a test item display form to be displayed on the screen (see FIG. 4) of the display unit 5b; and a display controller 54 configured to cause the display unit 5b to display test items in the display form received by the selection receiver 53. Functions of the order correction receiver 52 and the selection receiver 53 are performed via a screen 100 of the display unit 5b shown in FIG. 4.

### [Configuration of Display Screen of Display Unit]

The screen 100 shown in FIG. 4 is an order registration screen which shows a test order obtained from the host computer 9 in the ordering system 8 and which allows an addition or a correction of a test item included in the test order. The order registration screen 100 includes a patient attribute information display region 110 for displaying information about a patient, a test item display region 120 for displaying a test order requested by a medical doctor, a test item input region 130 for adding or correcting a test item, and other display regions.

Information and the like for identifying a patient, such as a patient ID, name, birth date, and the like, are displayed in the patient attribute information display region 110. In the test item display region 120, displayed are all test items, such as test items requested by a medical doctor and test items newly added by a laboratory technician or the like, for which tests are to be performed for the patient identified in the patient attribute information display region 110. In the test item input region 130, all test items for which tests can be performed by the analyzers 3 included in the test information system 1 are displayed in such a manner as to allow an addition or a correction of the content.

Specifically, in the test item input region 130 shown in FIG. 4, a plurality of buttons 131, each indicating a test item code (a number such as 0101.00 (4 digits.2digits)) and a test item name (ALP, AST, etc.), are displayed vertically and horizontally in a grid pattern. Further, a plurality of tabs 132, each indicating a test type such as “biochemistry”, “blood/coagulation”, “urine/stool”, “immunity/others”, “outsourcing”, or the like, are provided at the right end of the test item input region 130. All test items belonging to a selected tab 132 are displayed in the test item input region 130.

In the test item input region 130, the background color of a button 131 of a test item for which a test request has not been issued is displayed, for example, in white, and the background color of a button 131 of a test item for which a test request has been issued is displayed, for example, in yellow. Further, among test items for which test requests have been issued, with respect to a test item for which an urgent test is needed to be performed, the character color of the test item code and the test item name is displayed in a conspicuous color (for example, red) which is different from the character color of other buttons (for example, black). In this manner, the test item input region 130 is configured such that all of the test items are displayed therein, and concurrently, the background color, the character color, and the like of each button 131 allow a user to understand the state of the requests at a glance.

In order to add or correct a test item by using the test item input region 130, the user may click (select) a button 131 of a test item that the user wants to add/correct, by using the input device 5c such as a mouse or the like. For example, in a case where the user newly adds a test item, the user can add a request for the test item by clicking the button 131 of the test item once. When the request is added, the background color of the button 131 is changed from white to yellow, thereby allowing the user to visually recognize that the request has been added. Further, when the user clicks the button 131 once again, the character color of the test item name and the like is changed to red, thereby allowing the test item to be set to “urgent”. Further, when the user clicks the button 131 which is in the state of “urgent” once again, the background color of the button 131 is changed to white again, thereby allowing the test item to be set to “no request”. Thereafter, every time the user clicks the button 131, the user can change the state of the request of the test item, in the order of “requested”, “urgent”, and “no request”.

Further, in the case of correcting a test item that is already set to “requested”, when the user clicks the button 131 of the test item, the character color of the button 131 is changed from black to red, thereby allowing the state of the request of the test item to be corrected to “urgent”. Further, when the user clicks the button 131 once again, a cancellation line is added to the characters of the test item name and the like, thereby allowing the request to be canceled. Furthermore, when the user clicks the button 131 once again, the state of the request can be returned to “requested”. Thereafter, every time the user clicks the button, the user can correct the state of the request of the test item in the order of “urgent”, “request cancelled”, and “requested”.

It should be noted that the addition/correction of the content of the request using the test item input region 130 is not limited to the above method, and can be performed using another method. For addition/correction of the content of the request, the present embodiment allows selection of another method. Specifically, by switching tabs 133 of “attribute”, “slip”, “reference input”, and “code input” provided at an upper part of the test item input region 130, it is possible to select a method for adding/correcting the content of a request. The above-described method is a method for adding/correcting the content of a request when the “slip” tab 133 is selected. For example, when the “code input” tab 133 is selected, a user such as a laboratory technician or the like can add or correct a test item, by directly inputting a code corresponding to the test item.

Among test items included in a test order registered in the host computer 9 and test items added/corrected via the above-described test item input region 130, test items for the sample of the patient identified in the patient attribute information display region 110 are all displayed in the test item display region 120. The test item display region 120 of the present embodiment can display a plurality of test items in a plurality of display forms, thereby allowing a user to select one of the plurality of display forms.

Specifically, in the present embodiment, three tabs 121a to 121c of “all items”, “testing department”, and “bar code” are displayed in an upper part of the test item display region 120. By selecting one of the three tabs 121a to 121c using the input device 5c such as a mouse or the like, the three display forms can be switched to one another and the selected display form is displayed in the test item display region 120.

In the test item display region 120 shown in FIG. 4, test items are displayed in a display form that is displayed when the “all items” tab 121 a (hereinafter also referred to as “first display form”) has been selected. The first display form, which is displayed when the “all items” tab 121 a has been selected, displays the requested test items in a list.

Specifically, sets, each consisting of a test item code and a test item name, as in “0102.00 AST”, are displayed in the test item display region 120. Items which are in a main-sub relationship are displayed in a tree structure (hierarchical structure). For example, in a lower rank of a main-item “CBC”, sub-items “WBC”, “RBC”, “HGB”, and the like are displayed in branches of the tree structure.

When all the test items for which tests are performed are displayed in a list in this manner, it is possible to easily perform operations of, for example, checking the contents of the test order requested by a medical doctor against the test items actually inputted in the apparatus. This contributes to understanding of the input status and prevention of input errors.

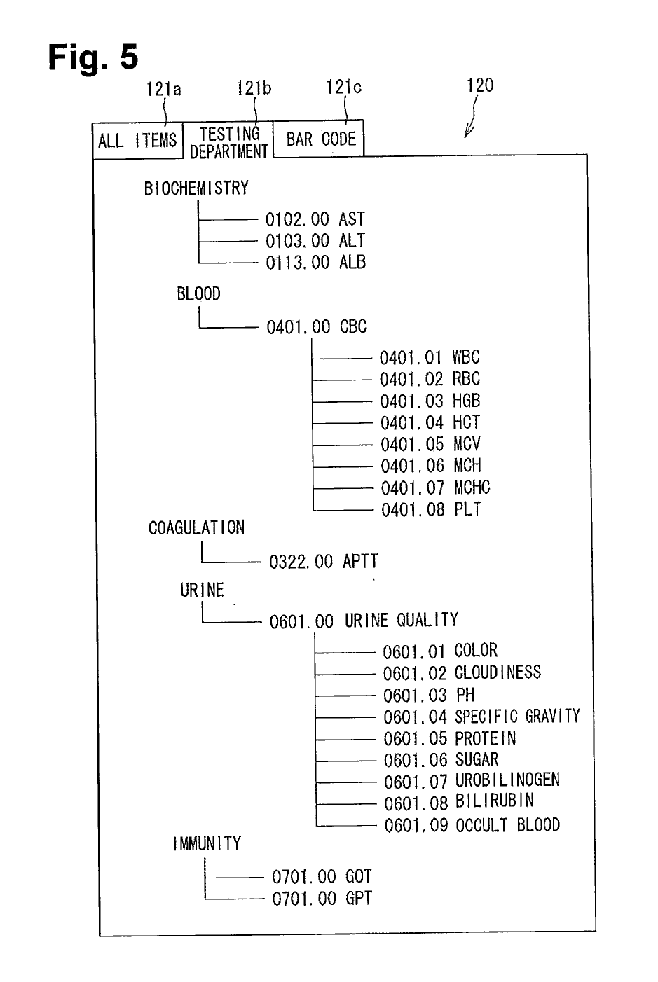

In the test item display region 120 shown in FIG. 5, test items are displayed in a display form that is displayed when the “testing department” tab 121b (hereinafter also referred to as “second display form”) has been selected. This “testing department” is a category that represents sections classified according to test types or organizations in the hospital. In an example shown in FIG. 5, test items are displayed, classified in five testing departments of: “biochemistry”, “blood”, “coagulation”, “urine”, and “immunity”. In the second display form, the testing departments, which serve as main items here, respectively, and their lower rank test items are displayed in a tree structure (hierarchical structure). In a case where a test item has sub-items, the sub-items are displayed under the test item in the tree structure. Here, the biochemical testing department denotes a testing department that performs tests for measuring the total protein in serum, the enzyme activity which is an index of organ functions, and the like. The blood testing department denotes a testing department that performs tests for measuring the red blood cell count, the white blood cell count, the platelet count, the hemoglobin concentration, and the like in whole blood. The coagulation testing department denotes a testing department that performs tests for measuring the coagulation function of plasma. The urine testing department denotes a testing department that performs a urine qualitative test for determining the presence or absence of protein, sugar, and red blood cells in urine, and a urinary sediment test for measuring red blood cells, white blood cells, epitheliocytes, casts, and bacteria. The immunological testing department denotes a testing department that performs tests for items such as hepatitis B, hepatitis C, tumor markers, thyroid hormones, and the like, by using serum.

The second display form, which is displayed when the “testing department” tab 121b has been selected, allows the user to understand at a glance to which testing department a test item for which tests are performed belongs. Therefore, for example, in a case where the content of a request has been added/corrected, or the like, the user can immediately recognize which testing department to inform to that effect. Thus, the second display form is especially useful in relatively large institutions such as those in which separate testing departments have separate laboratories.

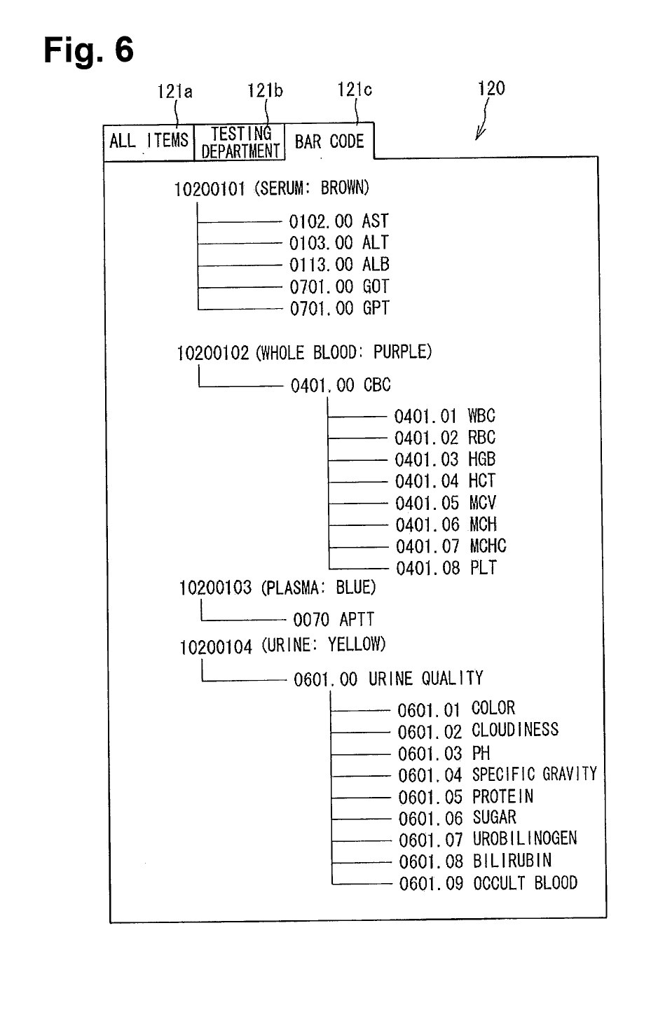

In the test item display region 120 shown in FIG. 6, test items are displayed in a display form that is displayed when the “bar code” tab 121c (hereinafter also referred to as “third display form”) has been selected. As shown in FIG. 9, a “bar code” is identification information (identification number) provided to a sample container 10 containing a sample collected from a patient, and is attached to the sample container 10, printed on a collection label 12. The number of sample containers 10 to be used in the tests and the amount of sample to be collected in a sample container 10 are automatically set, based on a test order registered in the host computer 9 by a medical doctor or the like and based on a test item added/corrected via the server management apparatus 5 or the like by a laboratory technician or the like. In addition, the collection label 12 to be attached to a sample container 10 is printed by the label printer 6.

A bar code 11 for identifying the sample number, and attribute information, such as sample number reception date, reception No., patient ID, patient name, name of sample container, test item, and the like (all not shown), are printed on the collection label 12. In a blood collection room or the like, a sample collected from a patient is poured into sample containers 10 each having a collection label 12 attached thereto, and each sample container containing the sample is transported to a corresponding laboratory where a corresponding test is to be performed, and then set in a corresponding analyzer 3.

As shown in FIG. 6, in the third display form, a plurality of test items are displayed in a state classified according to the identification numbers attached to respective sample containers. A number representing the bar code 11 attached to a corresponding sample container 10, and test items for which tests are to be performed on the sample contained in the sample container 10 are displayed in a tree structure. For example, in a lower rank of the sample container 10 having a bar code number “10200101” which is a main-item, test items “AST”, “ALT”, “ALB”, and the like which are sub-items are displayed. In a case where a test item has sub-items, the sub-items are displayed under the test item in the tree structure.

The third display form, which is displayed when the “bar code” tab 121c has been selected, allows the user to understand at a glance for which test item the sample container 10 is used. Therefore, after a test has been performed in an analyzer 3, the user can easily recognize to which analyzer 3 to set a sample container 10 next. Further, the third display form allows the user to immediately confirm the number of sample containers 10 necessary for the test. Accordingly, the user can easily and promptly determine whether all the necessary number of sample containers 10 have arrived at the laboratory.

It should be noted that in FIG. 6, the indications in parentheses displayed next to the bar code number are the type of the sample and the color of the cap attached to the sample container 10. Therefore, the user can accurately understand the type of the contained sample not only by the bar code number but also by the color of the cap attached to the sample container 10.

Each of the displays of the test items in the test item display region 120 shown in FIG. 4 to FIG. 6 is configured such that the state of the requests can be visually recognized as in the test item input region 130. Specifically, in a case where a test item is set to “urgent”, the character color of the test item in the test item display region 120 is displayed in a conspicuous color (for example, red) which is different from the character color of other test items (for example, black). With respect to a test item which has been cancelled, a cancellation line is added to the characters of the test item.

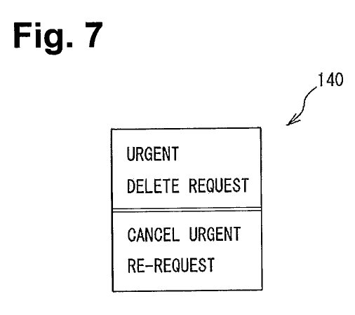

Further, according to the present embodiment, it is possible to correct the state of the request of a test item also in the test item display region 120. Specifically, when the user selects a test item that the user intends to correct by right-clicking the test item by means of a mouse, a pop-up window (correcting operation screen) 140 as shown in FIG. 7 is displayed on the screen. By selecting one of the items displayed in the pop-up window 140, the user can correct the state of the request of the test item.

Among the items displayed in the pop-up window 140 shown in FIG. 7, “urgent” can be selected only when the test item is set as an ordinary request, “urgent canceled” can be selected only when the test item is set to “urgent”. “Re-request” can be selected only when the test item has been canceled and deleted.

The above-described processes of changing the display form of the order registration screen 100 and adding/correcting a test item can be performed not only on the server management apparatus 5 but also on each client management apparatus 4.

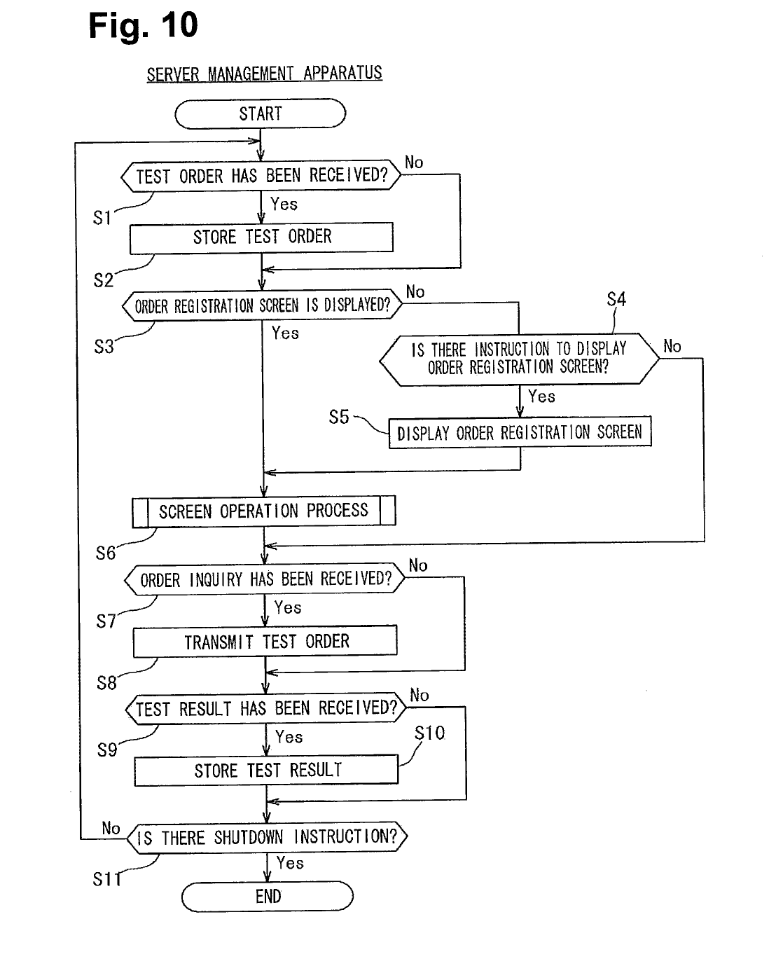

Next, with reference to FIG. 10, description will be given of a sequence of processes performed by the server management apparatus 5 which include the operations of adding/correcting a test item and a process of selecting a test item display form as described above.

First, a test order from a medical doctor has been registered in the host computer 9 in the ordering system 8. The controller 5a of the server management apparatus 5 determines, in step S1, whether the test order has been received from the host computer 9. Upon determining that the test order has been received, the controller 5a advances the processing to step S2, and upon determining that the test order has not been received, the controller 5a advances the processing to step S3. In step S2, the controller 5a performs a process of storing the received test order in a storage device such as the hard disk 501d or the like.

Next, in step S3, the controller 5a determines whether the order registration screen 100 (see FIG. 4) is being displayed on the display unit 5b of the server management apparatus 5. Upon determining that the order registration screen 100 is being displayed on the display unit 5b, the controller 5a advances the processing to step S6, and upon determining that the order registration screen 100 is not being displayed on the display unit 5b, the controller 5a advances the processing to step S4. In step S4, the controller 5a determines whether an instruction to display the order registration screen 100 has been received, and upon determining that the instruction has been received, the controller 5a advances the processing to step S5, and displays the order registration screen 100 on the display unit 5b. Upon determining that the instruction to display the order registration screen 100 has not been received, the controller 5a advances the processing to step S7.

In step S6, the controller 5a performs a screen operation process described below.

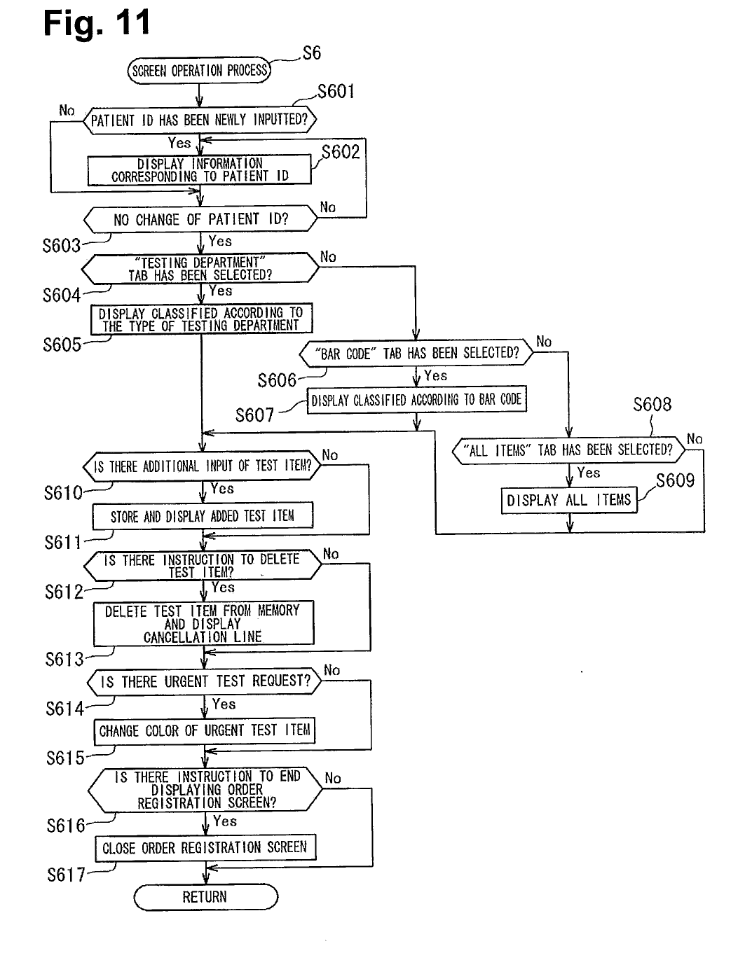

FIG. 11 is a flow chart showing a sequence of the screen operation process. In step S601, the controller 5a determines whether a patient ID has been newly inputted. Upon determining that a patient ID has been newly inputted, the controller 5a advances the processing to step S602, and upon determining that a patient ID has not been newly inputted, the controller 5a advances the processing to step S603. A patient ID can be inputted via the test item input region 130 that is displayed when the “attribute” tab 133 of the order registration screen 100 has been selected.

In step S602, the controller 5a displays information corresponding to the patient ID on the order registration screen 100 displayed on the display unit 5b. Next, in step S603, the controller 5a determines whether the patient ID has been changed. Upon determining that the patient ID has been changed, the controller 5a returns the processing to step S602, and upon determining that the patient ID has not been changed, the controller 5a advances the processing to step S604.

In step S604, the controller 5a determines whether the “testing department” tab 121b has been selected in the test item display region 120 (see FIG. 4). Upon determining that the “testing department” tab 121b has been selected, the controller 5a displays, in step S605, a plurality of test items in a state classified by testing departments (according to the types of the testing departments), in the test item display region 120 (see FIG. 5), and advances the processing to step S610.

Upon determining that the “testing department” tab has not been selected, the controller 5a determines, in step S606, whether the “bar code” tab 121c has been selected. Upon determining that the “bar code” tab 121c has been selected, the controller 5a displays, in step S607, the plurality of test items in a state classified by bar codes (according to the bar code numbers), in the test item display region 120 displayed on the display unit 5b (see FIG. 6), and advances the processing to step S610.

Upon determining in step S606 that the “bar code” tab 121c has not been selected, the controller 5a determines, in step S608, whether the “all items” tab 121a has been selected. Upon determining that the “all items” tab 121a has been selected, the controller 5a displays the test items in the all items display form (see FIG. 4), in the test item display region 120 displayed on the display unit 5b, and advances the processing to step S610. Also upon determining that the “all items” tab 121a has not been selected, the controller 5a advances the processing to step S610. It should be noted that when the order registration screen 100 is displayed on the display unit 5b in step S5, the “all items” tab 121a is selected.

In step S610, the controller 5a determines whether there has been an additional input of a test item via the test item input region 130 (see FIG. 4). Upon determining that there has been an additional input of a test item, the controller 5a performs a process of storing the added test item in the storage device, and displays the result reflecting the addition of the test item in the test item input region 130 and in the test item display region 120 which are displayed on the display unit 5b (step S611), and advances the processing to step S612. Also upon determining that there has not been an additional input of a test item, the controller 5a advances the processing to step S612.

Next, in step S612, the controller 5a determines whether there has been an instruction to delete a test item via the test item input region 130 or the test item display region 120. Upon determining that there has been an instruction to delete a test item, the controller 5a performs a process of deleting the test item from the storage device, and displays the result reflecting the deletion of the test item in the test item input region 130 and in the test item display region 120 which are displayed on the display unit 5b, that is, displays a cancellation line (step S613), and advances the processing to step S614. Also upon determining that there has not been an instruction to delete a test item, the controller 5a advances the processing to step S614.

Next, in step S614, the controller 5a determines whether there has been an instruction to set a test item to “urgent” via the test item input region 130 or the test item display region 120. Upon determining that there has been an instruction to set a test item to “urgent”, the controller 5a displays the result reflecting the setting of “urgent” in the test item input region 130 and in the test item display region 120 which are displayed on the display unit 5b, that is, performs a process of changing the character color of the code and name of the test item (step S615), and advances the processing to step S616. Also upon determining that there has not been an instruction to set a test item to “urgent”, the controller 5a advances the processing to step S616.

Next, in step S616, the controller 5a determines whether an instruction to end displaying the order registration screen 100 has been received. Upon determining that an instruction to end displaying the order registration screen 100 has been received, the controller 5a closes the order registration screen 100 displayed on the display unit 5b, and returns the processing. Upon determining that an instruction to end displaying the order registration screen 100 has not been received, the controller 5a returns the processing.

When starting a test, an analyzer 3 reads the bar code 11 shown in FIG. 9, which is attached to a sample container 10, and a client management apparatus 4 to which the analyzer 3 is connected inquires of the server management apparatus 5a about the test order of the sample container 10 with that bar code 11 attached.

The controller 5a of the server management apparatus 5 determines, in step S7 in FIG. 10, whether the inquiry of the test order from the client management apparatus 4 has been received. Upon determining that the inquiry of the test order has been received, the controller 5a transmits the test order to the client management apparatus 4 in step S8, and then, advances the processing to step S9. Also upon determining that the inquiry of the test order has not been received, the controller 5a advances the processing to step S9.

In step S9, the controller 5a of the server management apparatus 5 determines whether a test result has been received from the client management apparatus 4. Upon determining that the test result has been received, the controller 5a performs a process of storing the test result in the storage device in step S10, and then advances the processing to step S11. Also upon determining that the test result has not been received, the controller 5a advances the processing to step S11.

In step S11, the controller 5a determines whether a shutdown instruction has been received. Upon determining that the shutdown instruction has been received, the controller 5a shutdowns the server management apparatus 5. Upon determining that the shutdown instruction has not been received, the controller 5a returns the processing to step S1 and repeats the processes from step S1 to step S11.

As described above, in the test information system 1 according to the present embodiment, a plurality of test items included in the test order of a specific patient can be displayed in a state classified according to a category selected by the user, in the test item display region 120 displayed on the display unit 5b of the server management apparatus 5. Accordingly, the user can smoothly perform various testing operations, such as, for example, addition/correction of a test item, checking of the number of sample containers, checking of the arrival state of sample containers to the laboratory, and the like. Therefore, it is possible for any user to smoothly perform testing operations, irrespective of his or her level of skill in the testing operations.

Further, in the test information system 1 according to the present embodiment, the test item display region 120 and the test item input region 130 are concurrently displayed on the display unit 5b of the server management apparatus 5. Accordingly, the user can add a new test item or correct an already inputted test item, while confirming the test items of which requests have already been inputted and which are displayed in the test item display region 120. Therefore, it is possible to enhance the operativity and correctness of the operations of adding/correcting a test item.

Moreover, since a plurality of display forms are switched and a selected display form is displayed in the test item display region 120, the display area of the test item display region 120 can be suppressed compared with a case where these display forms are concurrently displayed on one screen, and the display screen of the display unit 5b can be effectively used to display other information.

Moreover, the user can easily switch the plurality of display forms by selecting one of the tabs 121a to 121c in the test item display region 120.

The present invention is not limited to the above described embodiment, and can be modified as appropriate without departing from the scope of the invention defined in the claims.

For example, in the present embodiment, the number of types of display forms of the test item display region 120 in the order registration screen 100 (see FIG. 4) displayed on the display unit 5b is three, that is, “all items”, “testing department”, and “bar code”. However, the number of the types may be two, four, or more. For example, in addition to or instead of a part of the three types, a display form of “analyzer” may be provided, and test items for which tests are to be performed may be classified according to the type of analyzer, such as biochemical analyzer, blood cell analyzer, blood coagulation measuring apparatus, urine analyzer, immune analyzer, and the like, and displayed in a tree structure. Further, a display form of “sample type” may be provided, and test item for which tests are to be performed may be classified according to the sample types such as “whole blood”, “serum”, “plasma”, “urine”, and the like, and displayed in a tree structure.

Further, the method of switching the display forms in the test item display region 120 is not limited to the method of selecting one of the tabs 121a to 121c. A method of switching the displays by clicking switch buttons separately provided on the screen, or by using a keyboard may be employed.

In the embodiment described above, in the display form shown under the tab of “testing department” (the second display form) in the test item display region 120 as shown in FIG. 5, the testing departments are classified in five types of “biochemistry”, “blood”, “coagulation”, “urine”, and “immunity”. However, the types of testing departments are not limited thereto. Further, tests using the same sample may be classified into one testing department, such as “biochemistry/immunity”. Moreover, the names of the testing departments are also not limited, and names that are appropriate for the medical institution or the like that has introduced the test information system 1 may be used.

Further, the “testing departments” are not limited to those classified according to test types. For example, departments may be classified according to organizations in the hospital. Further, one or more analyzers may belong to each testing department.

In the above embodiment, the test information system 1 includes the ordering system 8 having the host computer 9. However, the test information system 1 may be configured so as not to include them. In this case, the server management apparatus 5 may directly receive a registration (input) of a test order requested by a medical doctor or the like, by means of the function of the order obtainer (order receiver) 51 (see FIG. 3).

Further, in the above embodiment, both of the server management apparatus 5 and the client management apparatus 4 have the functions of displaying the order registration screen 100 and adding/correcting a test item. However, only one of the server management apparatus 5 and the client management apparatus 4 may have the functions.

What is claimed is:

1. A clinical test information system comprising:
a memory configured to store test orders of patients;
a display unit configured to display a screen showing a plurality of test items included in a test order of a specific patient, the test order being stored in the memory;
an input unit; and
a controller configured to:
receive, through an operation of the input unit, a selection of one of a first display form and a second display form for displaying the plurality of test items in a classified state; and
cause, if receiving the selection of the first display form, the display unit to display a screen showing the plurality of test items in a state classified according to a first category, and cause, if receiving the selection of the second display form, the display unit to display a screen showing the plurality of test items in a state classified according to a second category.

2. The clinical test information system according to claim 1, wherein
while the screen showing the plurality of test items in the state classified according to the first category is being displayed on the display unit, if the controller receives the selection of the second display form through an operation of the input unit, the controller causes the display unit to display the screen showing the plurality of test items in the state classified according to the second category.

3. The clinical test information system according to claim 1, wherein
the first category is a type of a testing department which performs a test, and
the first display form is a display form for displaying the plurality of test items in a state classified according to the type of the testing department.

4. The clinical test information system according to claim 3, wherein
the testing department includes at least one of a biochemical testing department, a blood testing department, a blood coagulation testing department, an immunological testing department, and a urine testing department.

5. The clinical test information system according to claim 1, wherein
the first category is a type of a testing apparatus which performs a test, and
the first display form is a display form for displaying the plurality of test items in a state classified according to the type of the testing apparatus.

6. The clinical test information system according to claim 5, wherein
the testing apparatus includes at least one of a biochemical analyzer, a blood cell analyzer, a blood coagulation measuring apparatus, an immune analyzer, and a urine analyzer.

7. The clinical test information system according to claim 1, wherein
the second category is an identification number identifying a sample container, and
the second display form is a display form for displaying the plurality of test items in a state classified according to the identification number of the sample container.

8. The clinical test information system according to claim 1, wherein
the second category is a type of a sample, and
the second display form is a display form for displaying the plurality of test items in a state classified according to the type of the sample.

9. The clinical test information system according to claim 1, wherein
the controller causes the display unit to display a screen showing the plurality of test items such that a test item among the plurality of test items that requires an urgent test to be performed can be identified.

10. The clinical test information system according to claim 1, wherein,
the controller causes the display unit to display a screen including a test item display region in which the plurality of test items are displayed and a test item input region for inputting a test item, and receives a test item inputted through an operation of the input unit in the test item input region.

11. The clinical test information system according to claim 1, wherein
the controller receives, through an operation of the input unit, a correction of a test item included in the test order stored in the memory, and causes the display unit to display a plurality of test items in a classified state reflecting the correction.

12. The clinical test information system according to claim 11, wherein
the controller receives, as the correction of the test item included in the test order stored in the memory, a deletion of the test item included in the test order through the operation of the input unit, and if receiving the deletion of the test item, displays a cancelation line over the deleted test item.

13. The clinical test information system according to claim 2, wherein
the controller causes the display unit to display the plurality of test items in a predetermined region in the screen, in the state classified according to the first category, and if receiving the selection of the second display form through an operation of the input unit, the controller causes the display unit to display the plurality of test items in the predetermined region, in the state classified according to the second category in place of the plurality of test items displayed in the state classified according to the first category.

14. The clinical test information system according to claim 13, wherein
the screen includes first and second tabs corresponding to the first and the second display forms, respectively, and
by a user selecting one of the first and the second tabs through an operation of the input unit, the controller receives the selection of the display form.

15. The clinical test information system according to claim 1, further comprising:
a plurality of testing apparatuses each configured to receive the test order stored in the memory, to test a sample of the specific patient in accordance with the plurality of test items included in the test order, and to transmit an obtained test result; and
a management apparatus configured to receive the test results transmitted by the plurality of testing apparatuses.

16. A clinical test information system comprising:
an order receiving section configured to receive test orders of patients;
a display unit configured to display a screen showing a plurality of test items included in a test order of a specific patient,
a selection receiving section configured to receive a selection of one of a first display form and a second display form for displaying the plurality of test items in a classified state; and
a display controller configured to:
cause, if the selection receiving section has received the selection of the first display form, the display unit to display a screen showing the plurality of test item in a state classified according to a first category, and cause, if the selection receiving section has received the selection of the second display form, the display unit to display a screen showing the plurality of test items in a state classified according to a second category.

17. A non-transitory storage medium which stores programs executable comprehensively by at least one processor, the programs causing the at least one processor to:
obtain test orders of patients;
receive a selection of one of a first display form and a second display form for displaying a plurality of test items included in a test order of a specific patient in a classified state; and
cause, if receiving the selection of the first display form, a display unit to display a screen showing the plurality of test items in a state classified according to a first category, and cause, if receiving the selection of the second display form, the display unit to display a screen showing the plurality of test items in a state classified according to a second category.

18. The non-transitory storage medium according to claim 17, wherein
the first category is a type of a testing department which performs a test, and
the first display form is a display form for displaying the plurality of test items in a state classified according to the type of the testing department.

19. The non-transitory storage medium according to claim 18, wherein
the testing department includes at least one of a biochemical testing department, a blood testing department, a blood coagulation testing department, an immunological testing department, and a urine testing department.

20. The non-transitory storage medium according to claim 17, wherein
the second category is an identification number identifying a sample container, and
the second display form is a display form for displaying the plurality of test items in a state classified according to the identification number of the sample container.
